(19) United States
(12) Patent Application Publication
(10) Pub. No.: US 2019/0037017 A1
(43) Pub. Date: Jan. 31, 2019

(54) INFORMATION PROCESSING DEVICE, INFORMATION PROCESSING METHOD, INFORMATION PROCESSING PROGRAM AND INFORMATION PROCESSING SYSTEM

(71) Applicant: NEC Corporation, Minato-ku, Tokyo (JP)

(72) Inventor: Yuji TOGASHI, Tokyo (JP)

(73) Assignee: NEC Corporation, Minato-ku, Tokyo (JP)

(21) Appl. No.: 16/085,625

(22) PCT Filed: Mar. 7, 2017
(86) PCT No.: PCT/JP2017/008999

§ 371 Date: Sep. 17, 2018

(30) Foreign Application Priority Data
Mar. 23, 2016 (JP) 2016-058492

(51) Int. Cl. H04L 29/08; H04W 8/24

(52) U.S. Cl. CPC H04L 67/1095; H04W 8/30; H04W 8/24; H04L 67/303

(57) ABSTRACT

The purpose of the present invention is to, even if a device is replaced, maintain continuity between data before and after the replacement of the device. An information processing device is provided with a reception unit that receives device data transmitted from a device. The information processing device is further provided with an identifier adding unit that acquires a correspondence relationship between a device identifier uniquely identifying the device and a shared identifier, and adds the shared identifier to the device data. The information processing device is still further provided with a transmission unit that transmits the device data to which the shared identifier is added.

### TECHNICAL FIELD

The present invention relates to an information processing apparatus, an information processing method, an information processing program, and an information processing system.

### BACKGROUND ART

In the technical field described above, PTL 1 discloses a technique that automatically associates a sensing object with sensing data.

### CITATION LIST

### Patent Literature

PTL 1: Japanese Unexamined Patent Application Publication No. 2011-18956

### SUMMARY OF INVENTION

### Technical Problem

However, even when a device is replaced, by the technique described in the above literature, it is not capable of maintaining continuity between data before and after the replacement of the device.

An object of the present invention is to provide a technique for solving the problem described above.

### Solution to Problem

In order to solve the above problem, an information processing apparatus according to the present invention includes: reception means for receiving device data transmitted from a device; identifier adding means for acquiring a correspondence relationship between a device identifier that uniquely identifies the device and a shared identifier, and adding the shared identifier to the device data; and transmission means for transmitting device data to which the shared identifier is added.

In order to solve the above problem, an information processing method according to the present invention includes: a reception step of receiving device data transmitted from a device; an identifier adding step of acquiring a correspondence relationship between a device identifier that uniquely identifies the device and a shared identifier, and adding the shared identifier to the device data; and a transmission step of transmitting device data to which the shared identifier is added.

In order to solve the above problem, an information processing program according to the present invention causing a computer to execute: a reception step of receiving device data transmitted from a device; an identifier adding step of acquiring a correspondence relationship between a device identifier that uniquely identifies the device and a shared identifier, and adding the shared identifier to the device data; and a transmission step of transmitting device data to which the shared identifier is added.

In order to solve the above problem, an information processing system according to the present invention includes a device and an information processing apparatus, the information processing apparatus including: reception means for receiving device data transmitted from the device; identifier adding means for acquiring a correspondence relationship between a device identifier that uniquely identifies the device and a shared identifier, and adding the shared identifier to the device data; and transmission means for transmitting device data to which the shared identifier is added.

### Advantageous Effects of Invention

According to the present invention, even when a device is replaced, continuity between data before and after the replacement of the device can be maintained.

### BRIEF DESCRIPTION OF DRAWINGS

FIG. 1 is a block diagram illustrating a configuration of an information processing apparatus according to a first example embodiment of the present invention;

FIG. 2A is a diagram explaining an overview of a configuration of an information processing system according to a second example embodiment of the present invention;

FIG. 2B is a sequence diagram explaining an overview of an operation (identifier adding) of the information processing system according to the second example embodiment of the present invention;

FIG. 2C is a sequence diagram explaining an overview of an operation (disconnection detection) of the information processing system according to the second example embodiment of the present invention;

FIG. 2D is a sequence diagram explaining an overview of an operation (replacement with a new device) of the information processing system according to the second example embodiment of the present invention;

FIG. 2E is a sequence diagram explaining an overview of an operation (addition of a new device) of the information processing system according to the second example embodiment of the present invention;

FIG. 3 is a block diagram illustrating a configuration of an information processing apparatus included in the information processing system according to the second example embodiment of the present invention;

FIG. 4A is a diagram illustrating a configuration of a determination table provided in the information processing apparatus included in the information processing system according to the second example embodiment of the present invention;

FIG. 4B is a diagram illustrating a configuration of a shared ID table provided in the information processing apparatus included in the information processing system according to the second example embodiment of the present invention;

FIG. 5 is a block diagram illustrating a hardware configuration of the information processing apparatus according to the second example embodiment of the present invention;

FIG. 6 is a flowchart illustrating a processing procedure (replacement with a device) of the information processing apparatus according to the second example embodiment of the present invention;

FIG. 7 is a block diagram illustrating a configuration of an information processing apparatus included in an information processing system according to a third example embodiment of the present invention;

FIG. 8 is a diagram illustrating a configuration of a presumption table provided in the information processing apparatus included in the information processing system according to the third example embodiment of the present invention;

FIG. 9 is a block diagram illustrating a hardware configuration of the information processing apparatus included in the information processing system according to the third example embodiment of the present invention;

FIG. 10 is a flowchart illustrating a processing procedure of the information processing apparatus included in the information processing system according to the third example embodiment of the present invention;

FIG. 11 is a diagram explaining an overview of a configuration of an information processing system according to a fourth example embodiment of the present invention;

FIG. 12A is a diagram illustrating a configuration of a determination table provided in an information processing apparatus included in the information processing system according to the fourth example embodiment of the present invention;

FIG. 12B is a diagram illustrating a configuration of a shared ID table provided in the information processing apparatus included in the information processing system according to the fourth example embodiment of the present invention; and

FIG. 13 is a block diagram illustrating a hardware configuration of the information processing apparatus included in the information processing system according to the fourth example embodiment of the present invention.

### EXAMPLE EMBODIMENT

Example embodiments for carrying out the present invention will be described below in detail by way of illustration with reference to the drawings. However, configurations, numerical values, process flows, functional elements and the like described in the following example embodiments are illustrative only, variations and modifications thereof may be made at will, and they are not intended to limit the technical scope of the present invention to the following description.

### First Example Embodiment

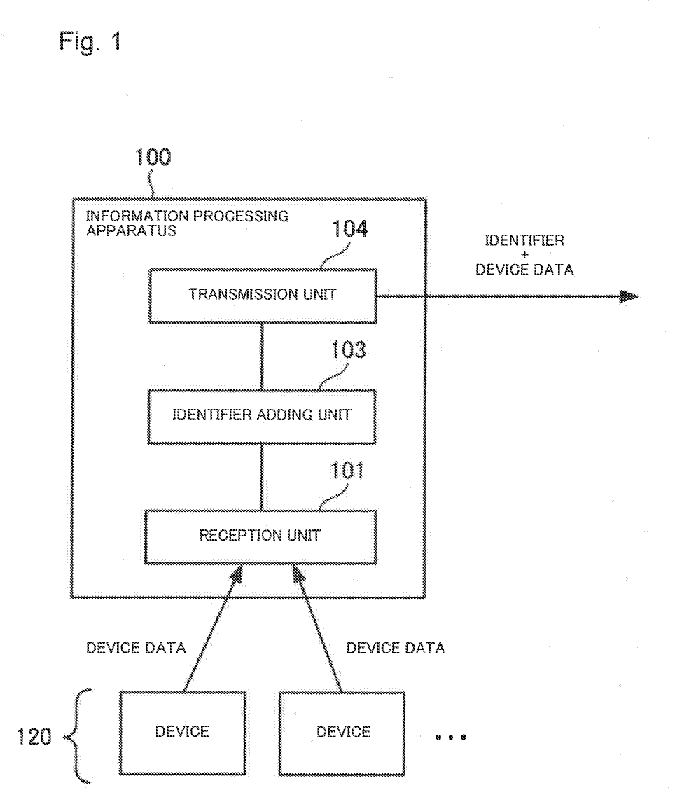

An information processing apparatus 100 as a first example embodiment of the present invention will be described by using FIG. 1. The information processing apparatus 100 is an apparatus that collects device data from devices and transmits the collected device data to a user or another apparatus. As shown in FIG. 1, the information processing apparatus 100 includes a reception unit 101, an identifier adding unit 103 and a transmission unit 104.

The reception unit 101 receives device data transmitted from a device 120. The identifier adding unit 103 acquires a correspondence relationship between a device identifier for uniquely identifying the device and a shared identifier and adds the shared identifier to the device data. The transmission unit 104 transmits the device data to which the shared identifier is added.

According to the present example embodiment, even when a device is replaced, continuity between data before and after the replacement of the device can be maintained because a shared identifier is added to device data.

### Second Example Embodiment

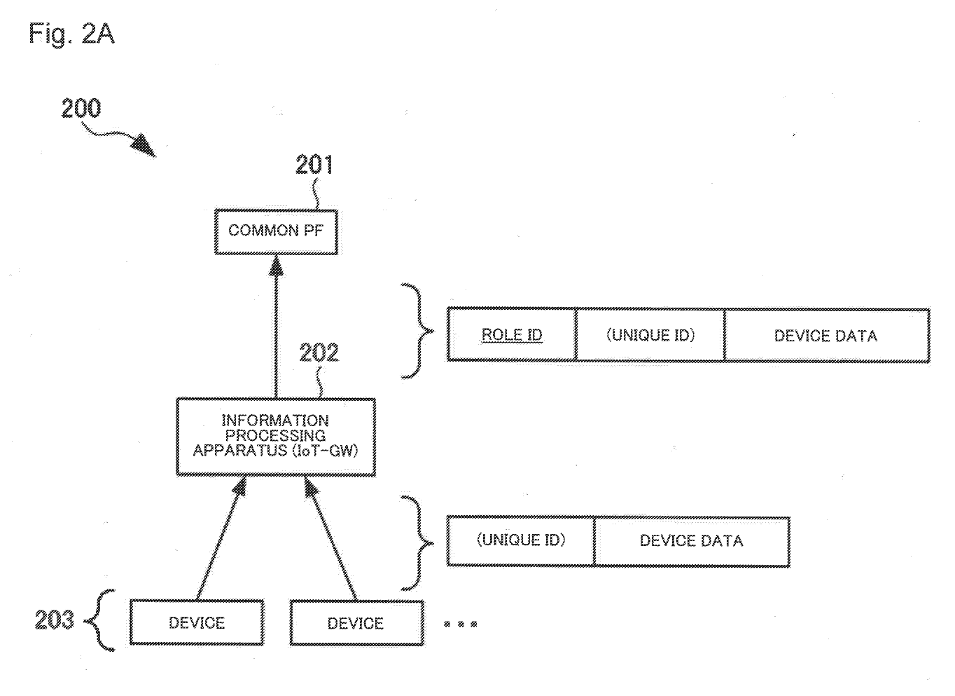

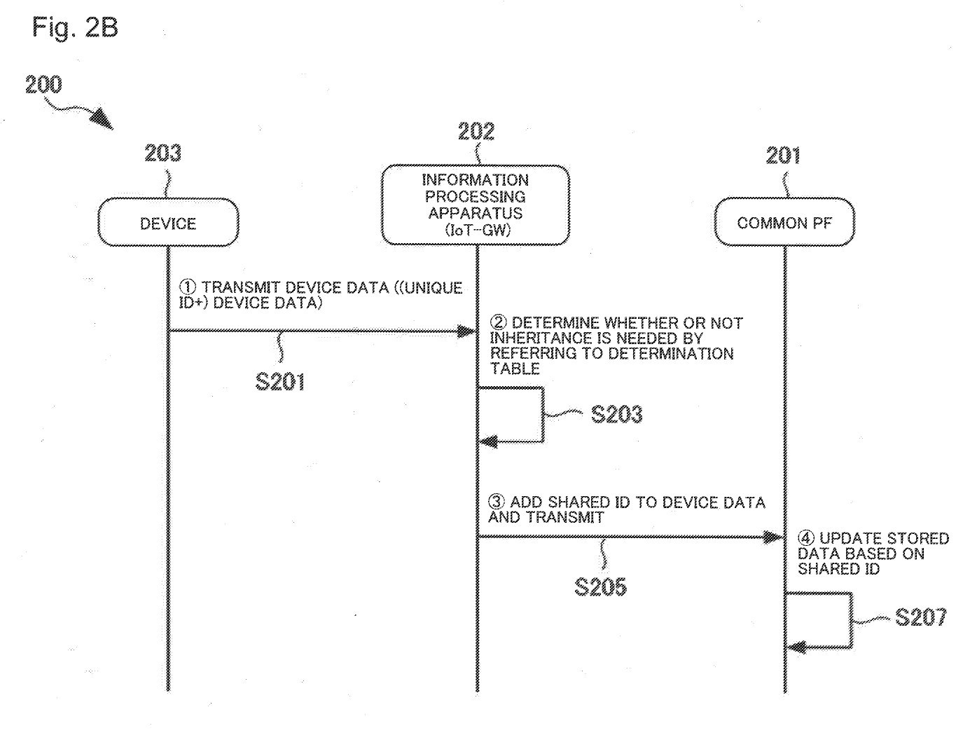

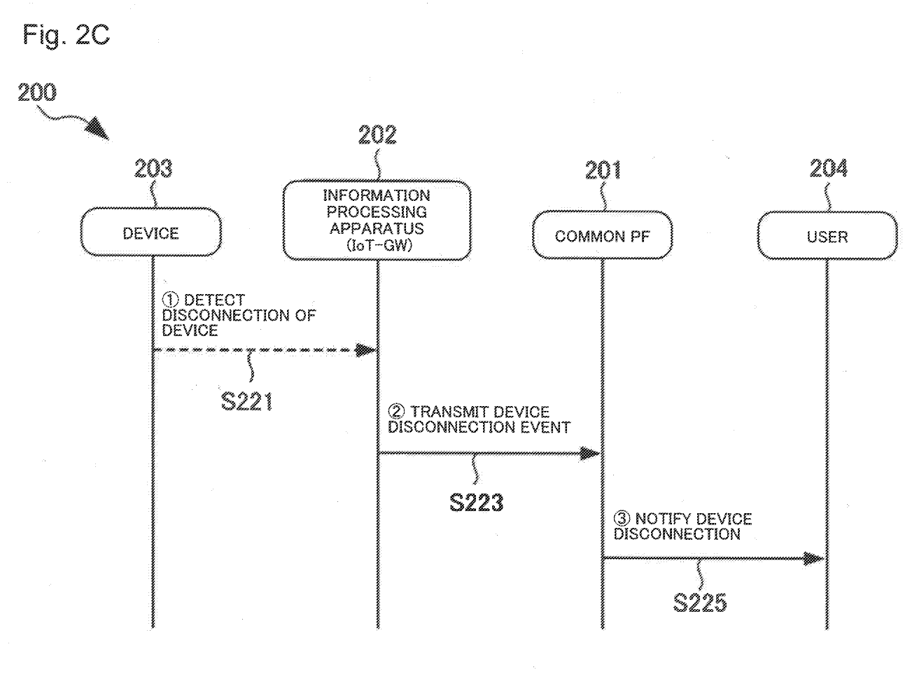

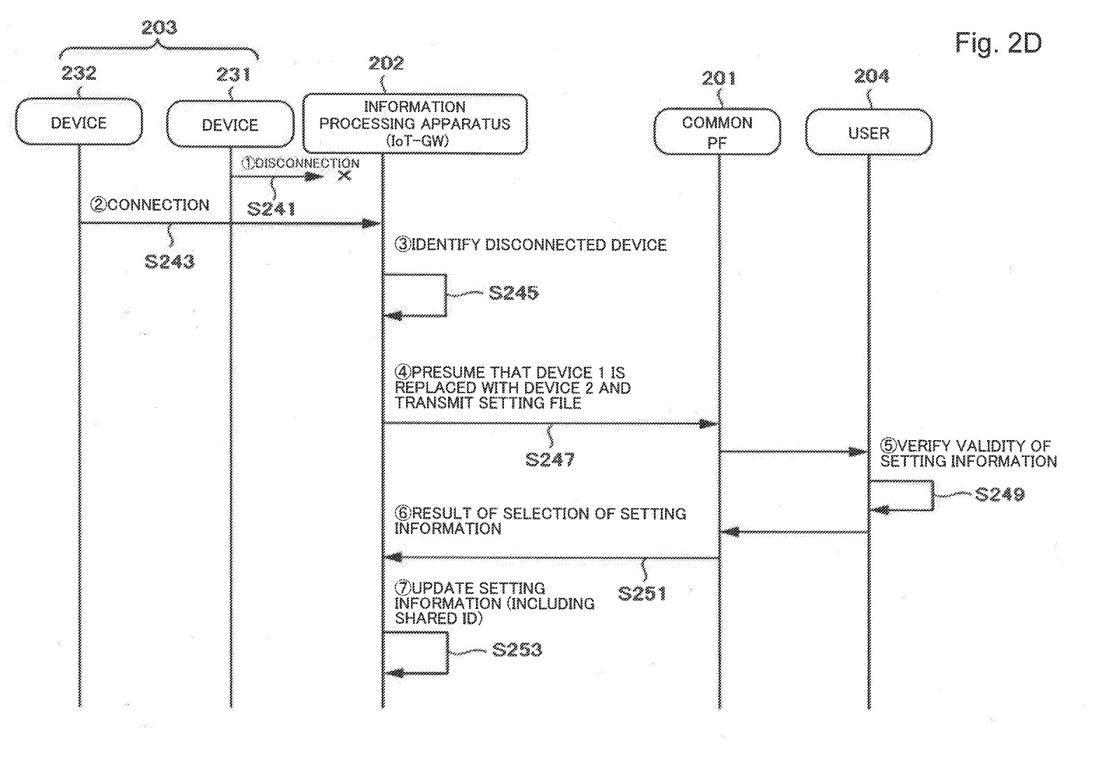

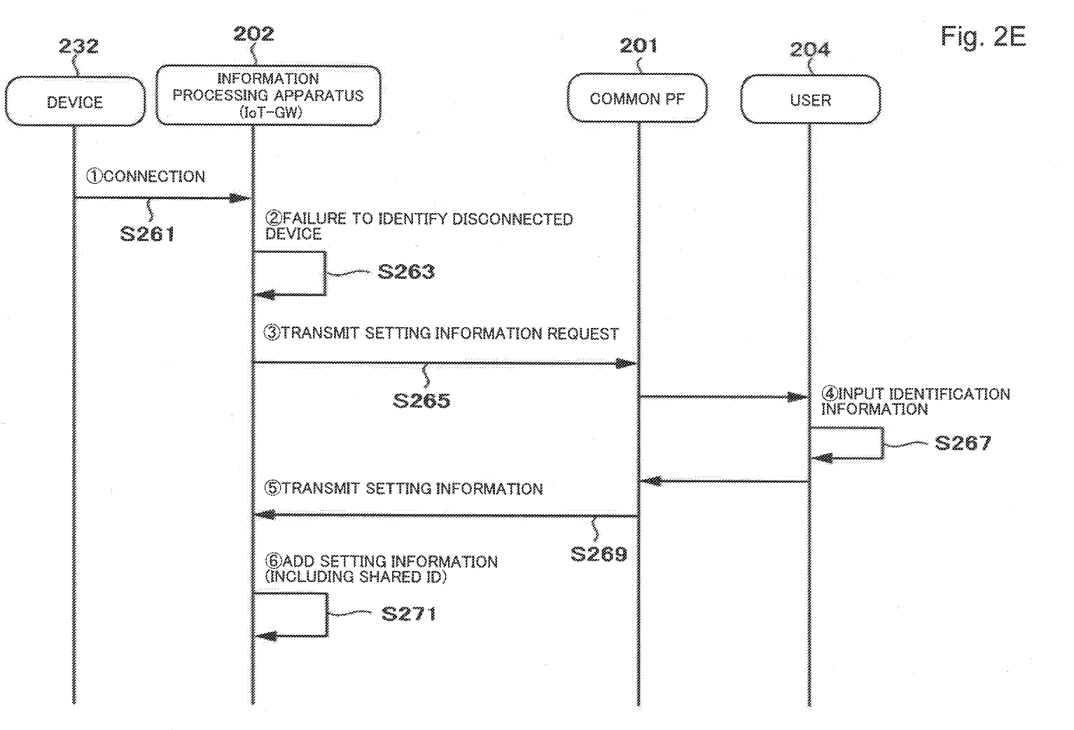

An information processing system 200 according to a second example embodiment of the present invention will be described next by using FIGS. 2A to 6.

<Prerequisite Technology>

Internet of Things (IoT) services in the prerequisite technology, a unique identifier (ID) (such as a media access control (MAC) address) of a device such as a sensor is often directly used as a device identifier (unique ID). In this case, when a failed device is replaced with a new device due to a failure or replacement of the device, the unique identifier is also changed. On the other hand, when a device transmits device data to a common platform (common PF) or a gateway (GW), the device adds a unique ID to the device data and transmits the device data.

Accordingly, at the common PF that collects device data transmitted from a device, a different unique ID is added to device data (collected data) before and after the replacement and therefore the device data are separated and cannot be handled as data having continuity.

<Technique of the Present Example Embodiment>

FIG. 2A is a diagram for explaining an overview of a configuration of the information processing system 200 according to the present example embodiment. The information processing system 200 includes a common PF 201, an information processing apparatus 202 (IoT-GW), and devices 203.

The common PF 201 collects and stores device data transmitted from a plurality of devices 203 through the information processing apparatus 202. In addition, when collected data satisfy a predefined condition, the common PF 201 notifies an administrator or the like.

The information processing apparatus 202 mediates communication between the plurality of devices 203 and the common PF 201 and transmits device data transmitted from the devices 203 to the common PF 201. For device data transmitted from a device 203 that needs inheritance of device data, the information processing apparatus 202 transmits the device data to which a shared identifier (shared ID) is added. Note that the information processing apparatus 202 may add a shared ID to device data transmitted from a device 203, regardless of whether or not inheritance of device data is needed. Note that while an example in which a unique ID is added to device data transmitted by a device 203 and the added device data are transmitted is described in the figure, addition of a unique ID is not essential, but is optional. The same applies in the following description.

A shared ID herein is an identifier that can identify the fact that, even when a device 203 is replaced, the device 203 has the same meaning before and after the replacement. In other words, the shared ID is an identifier that can be used in common before and after the replacement of the device 203.

Each device 203 includes a sensing unit and a communication control unit that controls communication with the GW. Each device 203 is uniquely identified by a unique ID (device ID) which is a unique ID that uniquely identifies each device.

The common PF 201 and the information processing apparatus 202 are interconnected through a wide-area network such as the Internet or a cellular network, but the interconnection is not limited to these. Further, the information processing apparatus 202 and the devices 203 are interconnected through a short-range network such as wireless fidelity (Wi-Fi) or near field communication (NFC), but the interconnection is not limited to these.

An operation of the information processing system 200 according to the present example embodiment includes following three sequences. (1) Adding a share ID to device data: in order to ensure continuity of device data, the information processing apparatus 202 adds a shared ID to the device data for a device 203 that is likely to allow the device data to be inherited. Continuity of the device data is maintained by using the shared ID as a key. (2) Disconnection of an existing device: a device 203 connected to the information processing apparatus 202 is disconnected from the information processing apparatus 202. (3) Addition of a new device: after the information processing apparatus 202 detects connection of a new device, a shared ID added to device data of an existing device is inherited to the new device when the new device is a device replacing the existing device that has been disconnected in (2).

FIG. 2B is a sequence diagram explaining an overview of an operation (identifier adding) of the information processing system 200 according to the present example embodiment. In step S201, a device 203 transmits device data to which a unique ID of the device is added to the information processing apparatus 202. In step S203, the information processing apparatus 202 determines whether or not the device data are from a device 203 that needs inheritance by referring to a determination table. For example, the information processing apparatus 202 determines whether or not inheritance is needed, based on the presence or absence of a flag that is stored in the determination table and indicates whether or not inheritance is needed.

When it is determined in step S203 that inheritance is needed, the information processing apparatus 202 adds a shared ID to device data and transmits the device data to the common PF 201 in step S205. In step S207, the common PF 201 updates stored device data by referring to the shared ID added to the transmitted device data.

FIG. 2C is a sequence diagram explaining an overview of an operation (disconnection detection) of the information processing system 200 according to the present example embodiment. In step S221, the information processing apparatus 202 detects disconnection of an existing device 203. In a method for detecting device disconnection in the case of planned replacement or removal of an unnecessary device, the information processing apparatus 202 is notified that the device 203 has been disconnected by a user performing a predetermined disconnection operation, for example. Further, in the case of a failure of a device 203, for example, it is detected that the device 203 has been disconnected when there has been no communication from the device 203 to the information processing apparatus 202 for a prescribed period of time. In other words, the information processing apparatus 202 detects disconnection of the device 203, based on a reception interval at which the information processing apparatus 202 receives device data from the device 203.

In step S223, the information processing apparatus 202 transmits information indicating an event of device disconnection to the common PF 201. The information includes the unique ID of the disconnected device 203. In step S225, the common PF 201 notifies a user 204 (operator) that the existing device 203 has been disconnected. A way of notification here is to use an electronic mail or a short message service (SMS), but is not limited to these.

In the case of planned replacement or a failure, the user 204 connects a device that serves as a substitute for the existing device to the information processing apparatus 202 after step S225. Further, in the case of a failure, the failure may be detected by using a self-diagnostic function of the device or regular inspection by the user 204 instead of the sequence described above and the device may be replaced with a new device based on the detection.

FIG. 2D is a sequence diagram explaining an overview of an operation (replacement with a new device) of the information processing system 200 according to the present example embodiment. FIG. 2E is a sequence diagram explaining an overview of an operation (addition of a new device) of the information processing system 200 according to the present example embodiment.

There may be the following three cases where a new device is connected to the information processing apparatus 202, i.e. a device for which a unique ID that is a device ID unique to the device is not registered is connected to the information processing apparatus 202: (1) planned replacement of an existing device, (2) replacement due to a failure of an existing device, and (3) addition of a new device that is not replacement of an existing device. In case (3), which is not replacement of an existing device, among these cases, there can be a case where a shared ID is added to the new device (an inheritance flag: “needed”) and a case where a shared ID is not added to the new device (the inheritance flag: “not needed”). Accordingly, the sequence in adding a new device can be classified into following two cases.

(A) a new device inherits the shared ID of a most recently disconnected existing device. This corresponds to the case of planned replacement of an existing device and the case of replacement of an existing device due to a failure. (B) A new shared ID is assigned to a new device. This is not replacement of an existing device but addition of a new device and includes both of a case where a shared ID is added to the new device and a case where a shared ID is not added to the new device.

In common to these cases, when the information processing apparatus 202 detects connection of a new device, the information processing apparatus 202 checks whether or not there is a most recently disconnected existing device that “needs” inheritance. When there is an existing device that “needs” inheritance, the information processing apparatus 202 presumes to be planned replacement of the device or replacement of the device due to a failure and notifies the operator (user 204) of a list of setting information (setting information list) of the device before the replacement as a candidate for setting information (a setting file) to be inherited to the device after the replacement. The operator selects a piece of setting information that is likely to be setting information of the device before the replacement from the list of setting information and notifies the piece of setting information to the information processing apparatus 202 through the common PF 201. The information processing apparatus 202 sets the selected piece of setting information on the device after the replacement. Note that the setting information includes a shared ID.

On the other hand, when there is not a most recently disconnected device that “needs” inheritance, the information processing apparatus 202 presumes that a new device is added rather than replacement of an existing device and requests the operator to input setting information. As part of the setting information, information indicating whether or not a shared ID needs to be added to the new device is included. Note that only when a shared ID “needs” to be added, a new shared ID is added to the new device. In this case, the information processing apparatus 202 may select and add an appropriate shared ID from among stocked shared IDs or may generate and add a new shared ID. The information processing apparatus 202 records the setting information input by the operator (user 204) regardless of whether or not a shared ID is added. Description will be provided below with reference to sequence diagrams in FIGS. 2D and 2E.

<(A) a New Device Inherits a Shared ID of a Most Recently Disconnected Existing Device>

Referring to FIG. 2D, a device 231 is disconnected in step S241. In step S243, a device 232 is connected to the information processing apparatus 202 in place of the device 231. In this case, setting information of the device 231 needs to be inherited to the device 232.

In step S245, when the information processing apparatus 202 detects connection of the new device 232, the information processing apparatus 202 identifies the most recently disconnected existing device 231. Specifically, the information processing apparatus 202 identifies the device 231 that is detected to have been disconnected by existing-device disconnection detection processing (FIG. 2C) among devices to which the inheritance flag “needed” is added in the determination table.

In step S247, when the information processing apparatus 202 identifies that the device 231 has been disconnected, the information processing apparatus 202 presumes that the newly connected device 232 has replaced the device 231, and notifies the operator (user 204) of the setting information of the device 231 through the common PF 201 as a candidate for setting information. Information required for transmitting device data, such as device data transmission timing and a data format, is registered in the setting information. Note that when there are a plurality of disconnected devices, setting information of all of the disconnected devices is notified to the user 204 as a candidate for setting information.

In step S249, the user 204 selects setting information that is likely to be appropriate from the notified setting information. In step S251, the user 204 makes a reply about the selected setting information through the common PF 201.

In step S253, the information processing apparatus 202 stores the setting information of the device 232. At this point of time, the shared ID added to the device 231 is assigned to the device 232. In this way, the same shared ID as the shared ID of the device 231 before replacement can be assigned to the device 232 after the replacement.

In step S247, there is a possibility that the presumption of replacement from the device 231 to the device 232 is erroneous. Typically, when a new device unrelated to an unnecessary device is added after removing the unnecessary device, the user 204 (operator) needs to input correct setting information, instead of selecting setting information that is likely to be appropriate in step S249. In this case, the rest of the sequence will follow the new device adding sequence.

Further, while selection and input by the user 204 (operator) are included in step S249 and step S251 in the sequence described above, step S249 and step S251 can be omitted when the result of the presumption in step S247 represents a single device. In other words, the setting information for the device 232 may be stored in step S253 as the result of the presumption. Since the result of the presumption can be wrong as stated above, the user 204 (operator) needs to manually correct shared ID information stored in the information processing apparatus 202 or the common PF 201 when the result of the presumption is wrong.

<(B) a New Shared ID is Assigned to a New Device>

Referring to FIG. 2E, a device 232 is connected to the information processing apparatus 202 in step S261. When the information processing apparatus 202 detects connection of the new device 232 in step S263, the information processing apparatus 202 attempts to identify a most recently disconnected existing device, as in step S245 of FIG. 2D. Specifically, the information processing apparatus 202 searches for a device that has been found to be disconnected in the existing-device disconnection detection processing (FIG. 2C) among devices that “need” inheritance in the determination table. However, since there is not a disconnected device, the information processing apparatus 202 fails to identify such a device. In this case, the information processing apparatus 202 presumes that a new device is added rather than replacement of an existing device.

In step S265, the information processing apparatus 202 notifies the user 204 (operator) through the common PF 201 that setting information for the device 232 needs to be input. In step S267, the user 204 inputs setting information for the device 232 and transmits the setting information to the common PF 201. The setting information includes at least information as to whether or not a shared ID needs to be added to the device 232.

In step S269, the common PF 201 transmits the setting information input in step S267 to the information processing apparatus 202. In step S271, the information processing apparatus 202 stores the setting information of the device 232. At this point of time, the information processing apparatus 202 adds a record of the device 232 to the determination table and sets a value that has been input in step S267 for indicating whether or not a shared ID needs to be added as a flag indicating whether or not inheritance is needed. In addition, when a shared ID “needs” to be added, the information processing apparatus 202 generates a new shared ID and records a correspondence relationship between the device ID of the device 232 and the shared ID in the shared ID table.

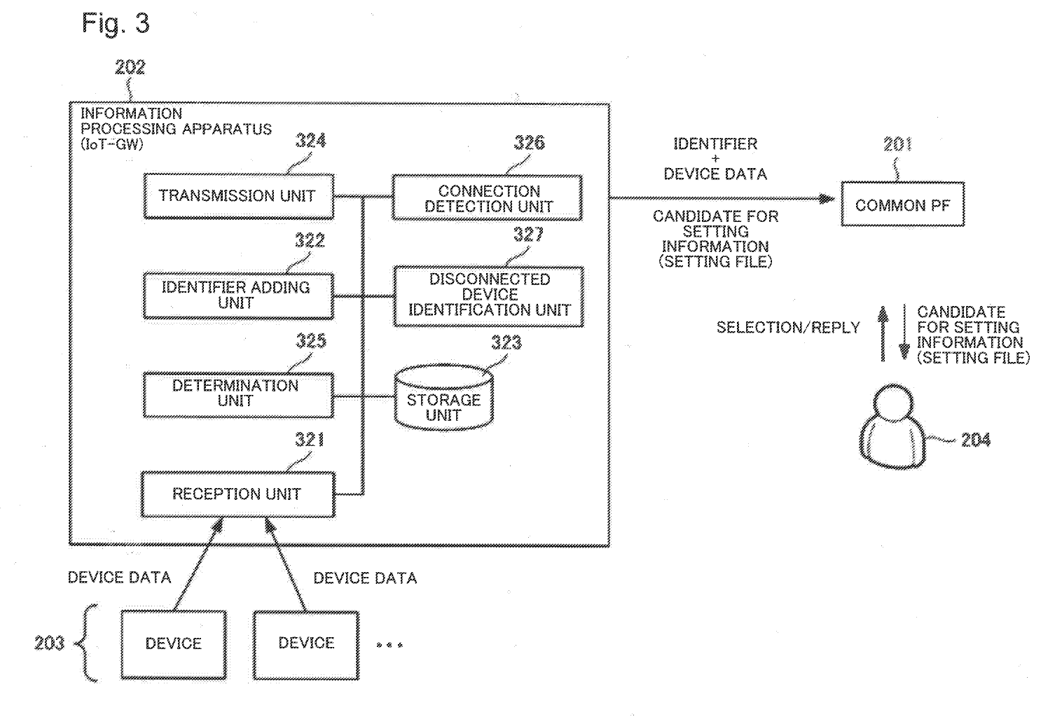

FIG. 3 is a block diagram illustrating a configuration of the information processing apparatus 202 included in the information processing system 200 according to the present example embodiment. The information processing apparatus 202 includes a reception unit 321, an identifier adding unit 322, a storage unit 323, a transmission unit 324, a determination unit 325, a connection detection unit 326 and a disconnected device identification unit 327.

The reception unit 321 receives device data sensed by a device 203 and transmitted to the information processing apparatus 202. When the device 203 transmits the sensed device data, the device 203 adds a unique ID (device ID) to the device data and then transmits it to the information processing apparatus 202.

The identifier adding unit 322 adds a unique ID (device ID) which is an identifier that identifies each device 203 to device data received from the device 203. The identifier adding unit 322 further adds a shared ID of each device 203 which can be used in common in the information processing system 200 to the device data received from the device 203. Note that a shared ID may be added to all device data or may be added to device data to which a shared ID needs to be added.

The storage unit 323 is a storage device and stores data such as a correspondence relationship between a unique ID (device ID) and a shared ID. Note that the storage unit 323 may be located outside the information processing apparatus 202. The same applies in example embodiments described below.

The transmission unit 324 transmits device data to which a unique ID (device ID) and a shared ID are added to the common PF 201. Further, in such a case where a device 203 is replaced, the transmission unit 324 transmits a candidate for setting information (a setting file) to a user 204 through the common PF 201.

The determination unit 325 determines whether or not to add a shared ID to device data transmitted from a device 203. For example, the determination unit 325 determines whether or not to add a shared ID by referring to a determination table. Note that the identifier adding unit 322 may add a shared ID, based on a result of determination by the determinant unit 325.

When a new device 203 is connected to the information processing apparatus 202, the connection detection unit 326 detects the connection of the new device.

The disconnected device identification unit 327 identifies a disconnected device 203 when the connection detection unit 326 detects connection of a new device. For example, when connection of a new device is detected, the disconnected device identification unit 327 identifies a most recently disconnected device. The disconnected device identification unit 327 then transmits candidates for setting information (a setting file) (a setting information list) of the most recently disconnected device to the transmission unit 324. Note that the disconnected device identification unit 327 may transmit, for example, candidates for a unique ID (a unique ID list) of the disconnected device 203 instead of transmitting candidates for setting information of the disconnected device 203.

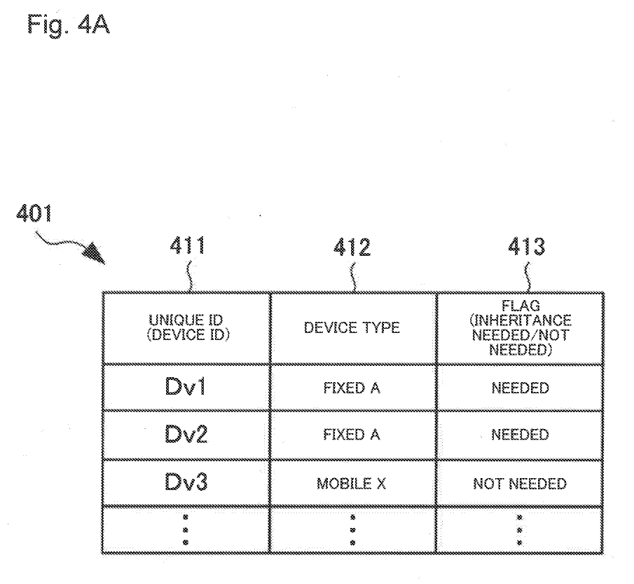

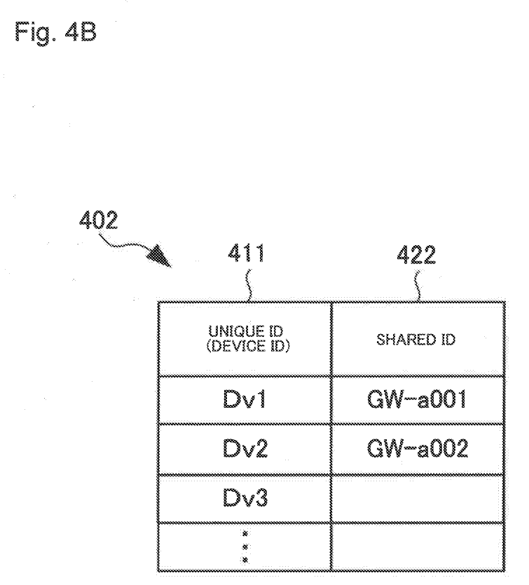

FIG. 4A is a diagram illustrating a configuration of a determination table 401 provided in the information processing apparatus 202 included in the information processing system 200 according to the present example embodiment. The determination table 401 stores a device type 412 and a flag 413 in association with a unique ID (device ID) 411. The device type 412 is information concerning the type of a device and includes, for example, information as to whether a device is a fixed device which does not move or a mobile device which moves. Note that information stored in the device type 412 is not limited to this and information concerning an object to be measured by the device may be stored.

The flag 413 is an indicator indicating whether or not device data of a device 203 (existing device 203) connected to the information processing apparatus 202 needs to be inherited when the device 203 is replaced. For example, the flag 413 “needed” indicates that the device 203 is a device that needs inheritance of device data even when the device 203 is replaced. The flag 413 “not needed” indicates that the device 203 is a device that does not need inheritance of device data even when the device 203 is replaced. The determination unit 325 determines whether or not to add a shared ID to device data by referring to the determination table 401.

A device that needs inheritance of a shared ID is a discrete device that is separated from an object to be measured. Examples of such devices include a device that senses environmental information in a particular site or a device that senses a state of a particular piece of equipment.

On the other hand, a device that does “not need” inheritance of a shared ID is a device that is integrated with an object to be measured and the object to be measured itself is also replaced by replacement of the device. Examples of such devices include a device that senses a state of a motor vehicle by using a sensor mounted on the motor vehicle. In this case, since the motor vehicle itself, which is an object to be measured, is replaced by replacement of the device, there is no need to maintain continuity of device data measured by the device.

FIG. 4B is a diagram illustrating a configuration of a shared ID table 402 provided in the information processing apparatus 202 included in the information processing system 200 according to the present example embodiment. The shared ID table 402 stores a shared ID 422 in association with a unique ID (device ID) 411. The identifier adding unit 322 acquires an association between a unique ID and a shared ID by referring to the shared ID table 402 and adds the shared ID to device data.

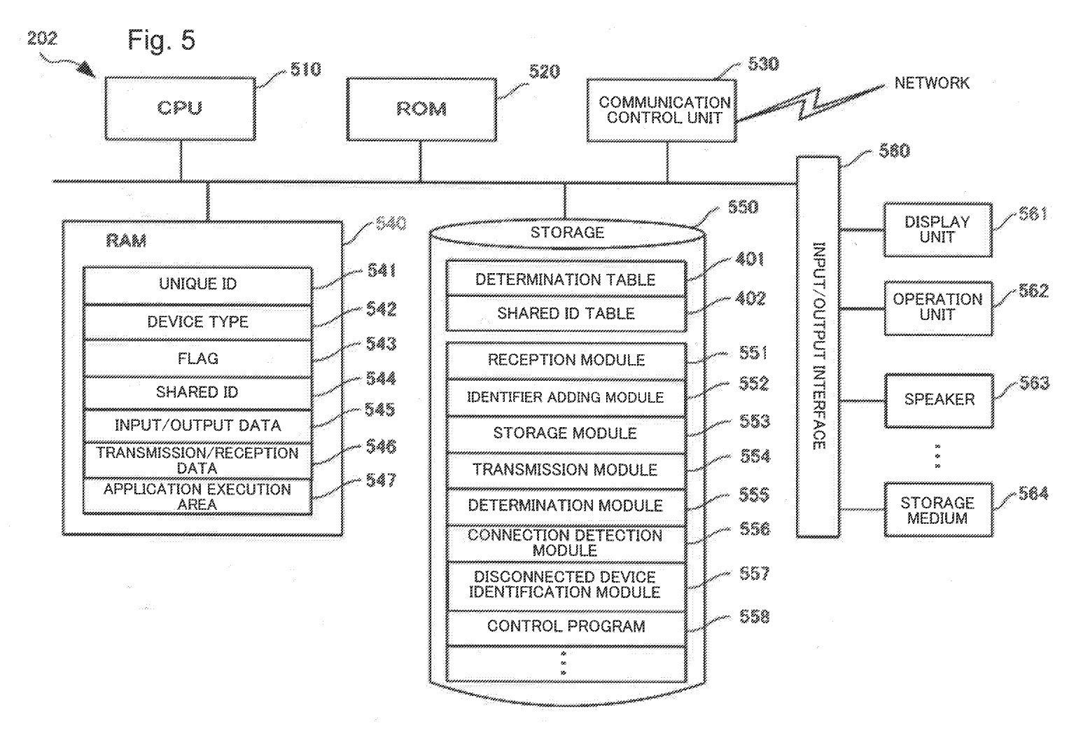

FIG. 5 is a block diagram illustrating a hardware configuration of the information processing apparatus 202 according to the present example embodiment.

A central processing unit (CPU) 510 is a processor for arithmetic control and implements functional components of the information processing apparatus 202 in FIG. 3 by executing a program. A read only memory (ROM) 520 stores initial data and fixed data for a program or the like, and other programs. A communication control unit 530 communicates with another apparatus and the like through a network.

Note that the CPU 510 is not limited to a single CPU, but may be a plurality of CPUs or may include a graphics processing unit (GPU) for image processing. It is desirable that the communication control unit 530 include a CPU that is independent of the CPU 510 and write or read transmission/reception data in an area in a random access memory (RAM) 540. It is also desirable that a direct memory access controller (DMAC) which transfers data between the RAM 540 and a storage 550 be provided (not depicted). Further, it is desirable that an input/output interface 560 include a CPU that is independent of the CPU 510 and write and read input/output data in an area in the RAM 540. Accordingly, the CPU 510 recognizes that data have been received in or transferred to the RAM 540 and processes the data. Further, the CPU 510 prepares results of processing in the RAM 540 and allows the communication control unit 530, the DMAC or the input/output interface 560 to subsequently transmit or transfer the results.

The RAM 540 is a random access memory used by the CPU 510 as a temporary-storage work area. An area for storing data required for implementing the present example embodiment is reserved in the RAM 540. A unique ID 541 is an identifier that can uniquely identify a device 203. A device type 542 is data concerning the type of a device 203. A flag 543 is an indicator indicating whether or not device data need to be inherited. These items of data are data loaded from the determination table 401 illustrated in FIG. 4A.

A shared ID 544 is an identifier that can be used in common for devices and that are loaded from the shared ID table 402 illustrated in FIG. 4B. Input/output data 545 are data input and output through the input/output interface 560. Transmission/reception data 546 are data transmitted and received through the communication control unit 530. The RAM 540 includes an application execution area 547 for executing various kinds of application modules.

A database and various kinds of parameters or the following data or programs required for implementing the present example embodiment are stored in the storage 550. The storage 550 stores the determination table 401 and the shared ID table 402. As shown in FIG. 4A, the determination table 401 is the table for managing a relationship among a unique ID 411, a device type 412 and a flag 413 indicating whether or not inheritance of device data is needed. As shown in FIG. 4B, the shared ID table 402 is the table for managing a relationship between a unique ID 411 and a shared ID 422.

The storage 550 further stores a reception module 551, an identifier adding module 552, a storage module 553, a transmission module 554, a determination module 555, a connection detection module 556, and a disconnected device identification module 557.

The reception module 551 is a module that receives device data from a device 203. The identifier adding module 552 is a module that adds a unique ID 411 (device ID) and a shared ID 422 to the device data received from a device 203. The storage module 553 is a module that stores a relationship between a unique ID 411 and a shared ID 422. The transmission module 554 is a module that transmits device data to which a unique ID 411 and a shared ID 422 are added. The determination module 555 is a module that determines whether or not to add a shared ID to the device data received from a device 203. The connection detection module 556 is a module that detects connection of a new device. The disconnected device identification module 557 is a module that identifies a disconnected device 203 when connection of a new device is detected. These modules 551 to 557 are read into the application execution area 547 in the RAM 540 and executed by the CPU 510. A control program 558 is a program for controlling the entire information processing apparatus 202.

The input/output interface 560 interfaces input/output data to and from input/output devices. A display unit 561 and an operation unit 562 are connected to the input/output interface 560. Further, a storage medium 240 may be connected to the input/output interface 560. Further, a speaker, which is an audio output unit, and a microphone, which is an audio input unit, or a GPS positioning unit may also be connected thereto. Note that programs or data related to general-purpose functions of the information processing apparatus 202 and other functions thereof that can be implemented are not depicted in the RAM 540 or the storage 550 illustrated in FIG. 5.

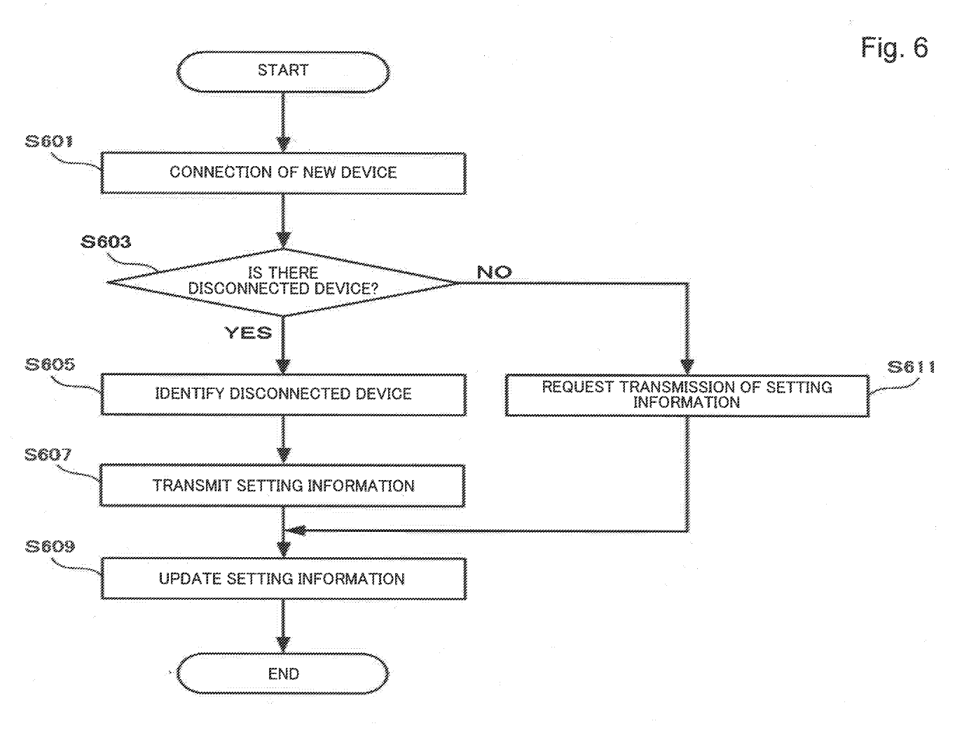

FIG. 6 is a flowchart illustrating a processing procedure (device replacement) of the information processing apparatus 202 according to the present example embodiment. The flowchart is executed by the CPU 510 in FIG. 5 using the RAM 540 to implement the functional components of the information processing apparatus 202 in FIG. 3. In step S601, the information processing apparatus 202 detects connection of a new device. In step S603, the information processing apparatus 202 determines whether or not there is a disconnected device.

When there is not a disconnected device (NO at step S603), the information processing apparatus 202 determines that a new device is added and proceeds to step S611. In step S611, the information processing apparatus 202 requests, through the common PF 201, a user to transmit setting information of the new device.

When there is a disconnected device (YES at step S603), the information processing apparatus 202 determines that an existing device is replaced and proceeds to step S605. In step S605, the information processing apparatus 202 identifies the disconnected device. In step S607, the information processing apparatus 202 transmits a candidate for setting information to the user through the common PF 201. Note that a plurality of candidates for setting information may be transmitted to the user. In step S609, the information processing apparatus 202 receives setting information selected by the user and updates the setting information. Note that the setting information includes a shared ID.

Note that the functions described above may be provided in the common PF 201. Specifically, the common PF 201 may add a shared ID to device data. The common PF 201 may notify the information processing apparatus 202 of a shared ID, for example. Further, these functions may be allotted between the information processing apparatus 202 and the common PF 201. A device 203 may be connected to the common PF 201 through the information processing apparatus 202 or may be directly connected to the common PF 201.

According to the present example embodiment, continuity between device data before and after device replacement (change) can be maintained even when the device replacement (change) occurs due to a failure, aging, or a lapse of useful life of a device.

### Third Example Embodiment

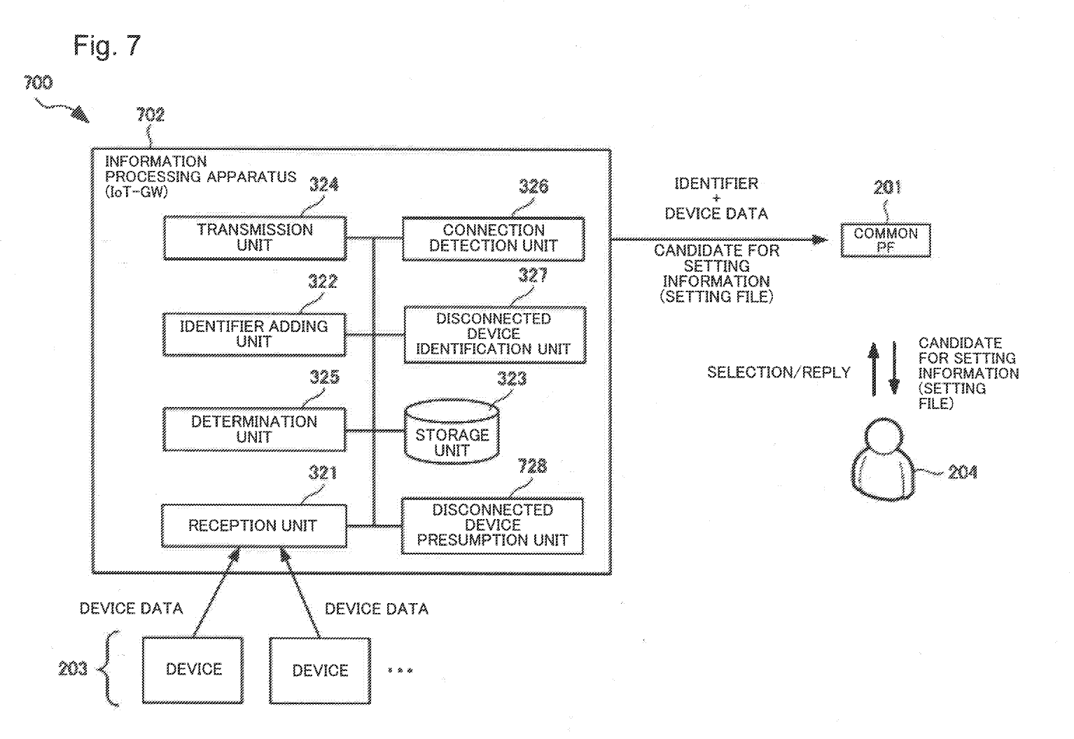

An information processing system 700 according to a third example embodiment of the present invention will be described next by using FIGS. 7 to 10. FIG. 7 is a diagram for explaining a configuration of an information processing apparatus 702 included in the information processing system 700 according to the present example embodiment. The information processing apparatus 702 according to the present example embodiment differs from the second example embodiment in that the information processing apparatus 702 includes a disconnected device presumption unit. The other configurations and operations are the same as those in the second example embodiment; therefore, the same reference signs are added to the same configurations and operations and detailed description thereof will be omitted.

The information processing apparatus 702 includes a disconnected device presumption unit 728. The disconnected device presumption unit 728 presumes a disconnected device. When there are a plurality of candidate devices as a result of the presumption, the disconnected device presumption unit 728 may rank and list the candidate devices.

For example, the disconnected device presumption unit 728 may rank presumed disconnected devices based on information such as a time at which each device is disconnected, a time after each device is disconnected, position information of each disconnected device, and a distance from the information processing apparatus 202. Further, the disconnected device presumption unit 728 may rank candidate devices based on a time elapsed since the last transmission of device data from each device, radio field intensity, or the like.

When there are a plurality of presumed disconnected devices, the devices may be ranked, for example, in order from a device closest to a reference position. This allows the user to select an appropriate device from among the presumed disconnected devices.

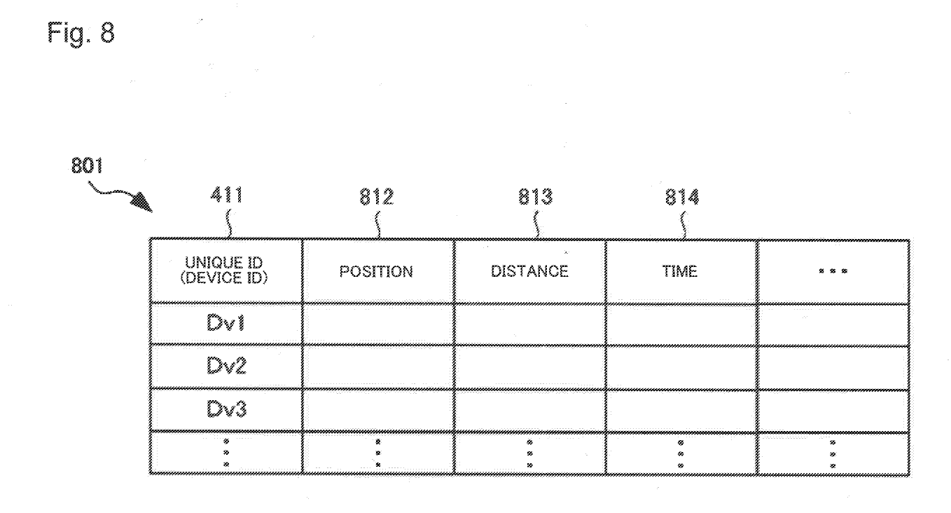

FIG. 8 is a diagram illustrating a configuration of a presumption table 801 provided in the information processing apparatus 202 included in the information processing system 700 according to the present example embodiment. The presumption table 801 stores a position 812, a distance 813, and a time 814 in association with a unique ID 411. The position 812 is information about a place (location) in which a device is installed. The distance 813 is information about the distance between a device and the information processing apparatus 202, but is not limited to this and may be the distance between a device and a predetermined access point, for example. The time 814 is information about the time elapsed since disconnection of a device or time such as a disconnection time of a device.

The disconnected device presumption unit 728 presumes a disconnected device by referring to the presumption table 801.

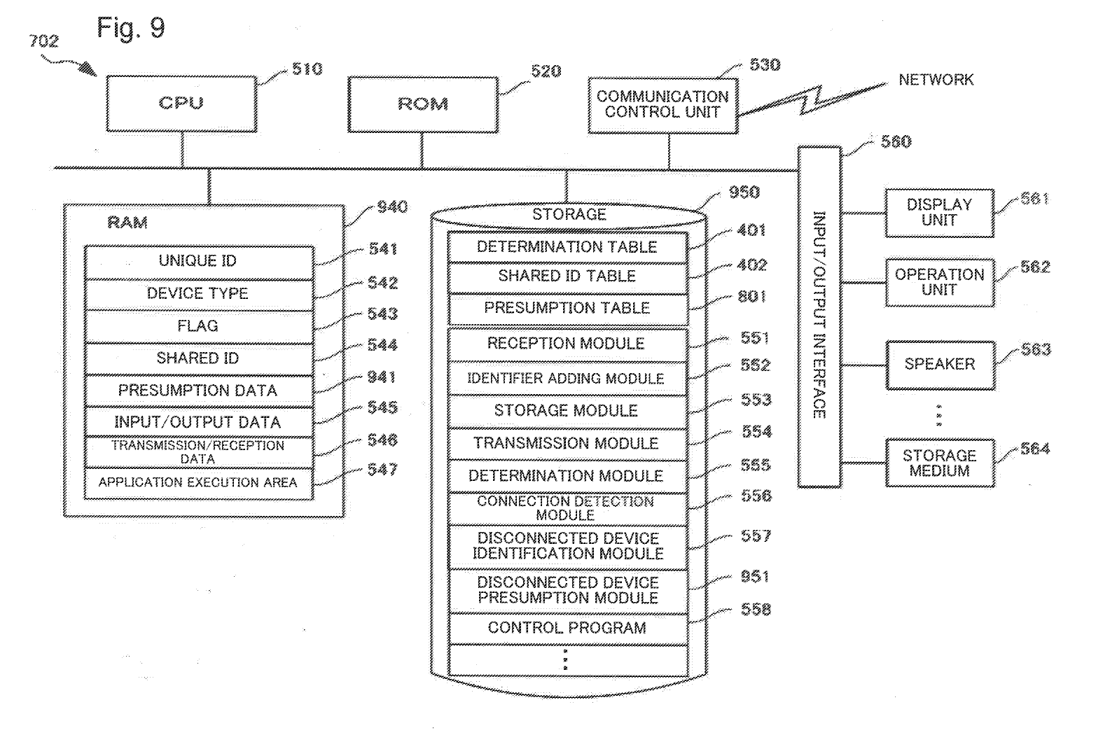

FIG. 9 is a block diagram illustrating a hardware configuration of an information processing apparatus 802 included in the information processing system 700 according to the present example embodiment. A RAM 940 is a random access memory used by the CPU 510 as a temporary-storage work area. An area for storing data required for implementing the present example embodiment is reserved in the RAM 940. Presumption data 941 are data used for identifying a disconnected device. The data are data loaded from the presumption table 801 illustrated in FIG. 8.

A database and various kinds of parameters or the following data or programs required for implementing the present example embodiment are stored in a storage 950. The storage 950 stores the presumption table 801. The presumption table 801 is a table of data, illustrated in FIG. 8, used for presuming a disconnected device.

The storage 950 further stores a disconnected device presumption module 951. The disconnected device presumption module 951 is a module that presumes a disconnected device. The module 951 is read into an application execution area 547 in the RAM 940 and executed by the CPU 510.

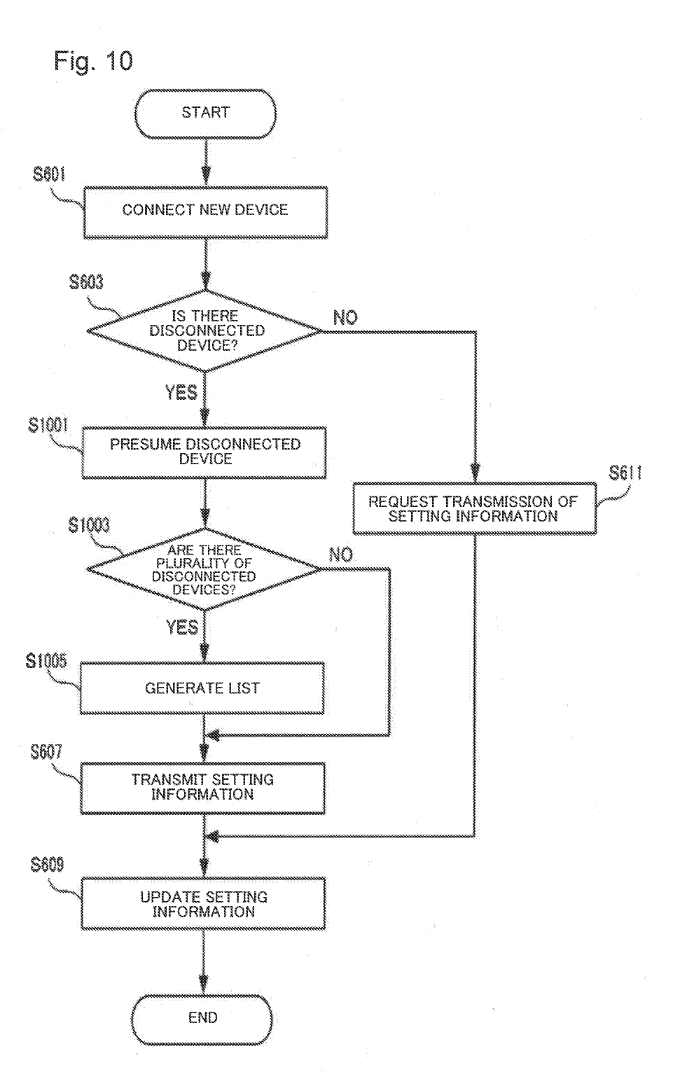

FIG. 10 is a flowchart illustrating a processing procedure of the information processing apparatus 802 included in the information processing system 700 according to the present example embodiment. The flowchart is executed by the CPU 510 in FIG. 9 using the RAM 540 to implement functional components of the information processing apparatus 802 in FIG. 8. In step S1001, the information processing apparatus 802 presumes a disconnected device. In step S1003, the information processing apparatus 802 determines whether or not there are a plurality of presumed disconnected devices. When there are a plurality of presumed disconnected devices (YES at step S1003), the information processing apparatus 802 proceeds to step S1005. Then, in step S1005, the information processing apparatus 802 generates a list, for example, in order from the device more likely to be disconnected, based on the position of each device, the distance of each device from the information processing apparatus 802 or the time elapsed since disconnection. When there are not a plurality of presumed disconnected devices (NO at step S1003), the information processing apparatus 802 proceeds to step S607.

According to the present example embodiment, since a disconnected device is presumed, the user can identify an inheritance device more properly and continuity of device data before and after device replacement (change) can be maintained.

### Fourth Example Embodiment

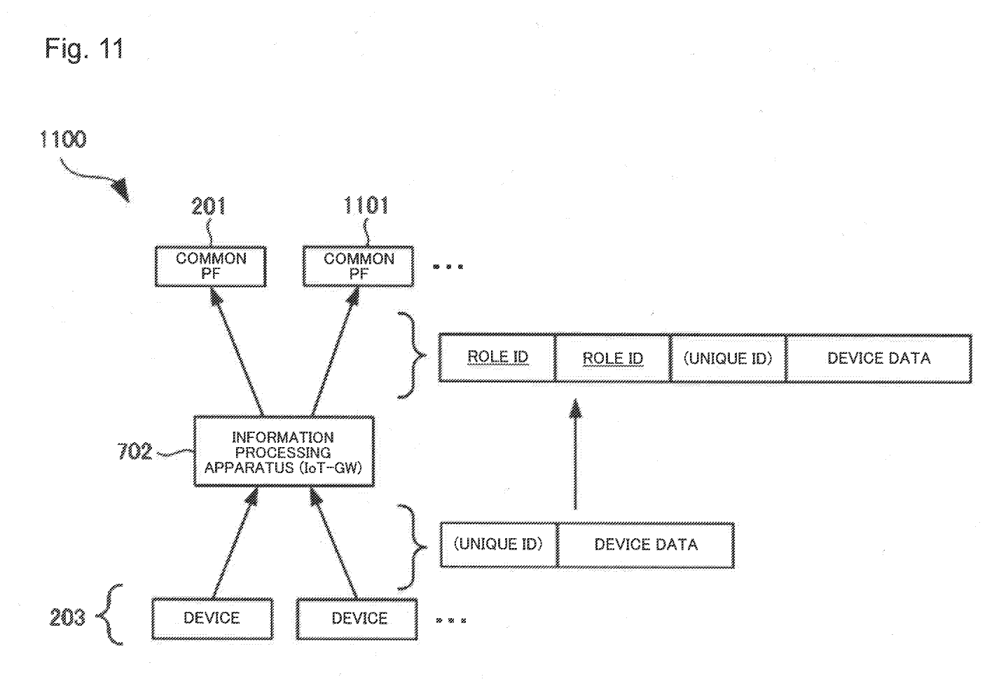

An information processing system according to a fourth example embodiment of the present invention will be described next by using FIGS. 11 to 13. FIG. 11 is a diagram explaining an overview of a configuration of the information processing system according to the present example embodiment. An information processing system 1100 according to the present example embodiment differs from the second example embodiment and the third example embodiment in that a plurality of common PFs are provided. Other configurations and operations are the same as those in the second example embodiment and the third example embodiment; therefore, the same reference signs are added to the same configurations and operations and detailed description thereof will be omitted.

The information processing apparatus 1100 includes common PFs 201 and 1101, an information processing apparatus 702 (IoT-GW), and devices 203. The information processing apparatus 702 mediates communication between a plurality of devices 203 and the common PFs 201 and 1101 and transmits device data transmitted from the devices 203 to the common PFs 201 and 1102.

For example, when one device 203 belongs to the plurality of common PFs 201 and 1101, the information processing apparatus 702 adds a plurality of shared IDs to device data of the device 203. One of the plurality of shared IDs is a shared ID of the device 203 for the common PF 201, for example, and another is a shared ID of the device 203 for the common PF 1101.

Note that while an example in which there are the two common PFs 201 and 1101 has been used in the description here, the number of common PFs is not limited to this and there may be three or more PFs. Further, a plurality of information processing apparatuses 702 may be provided depending on the number of common PFs.

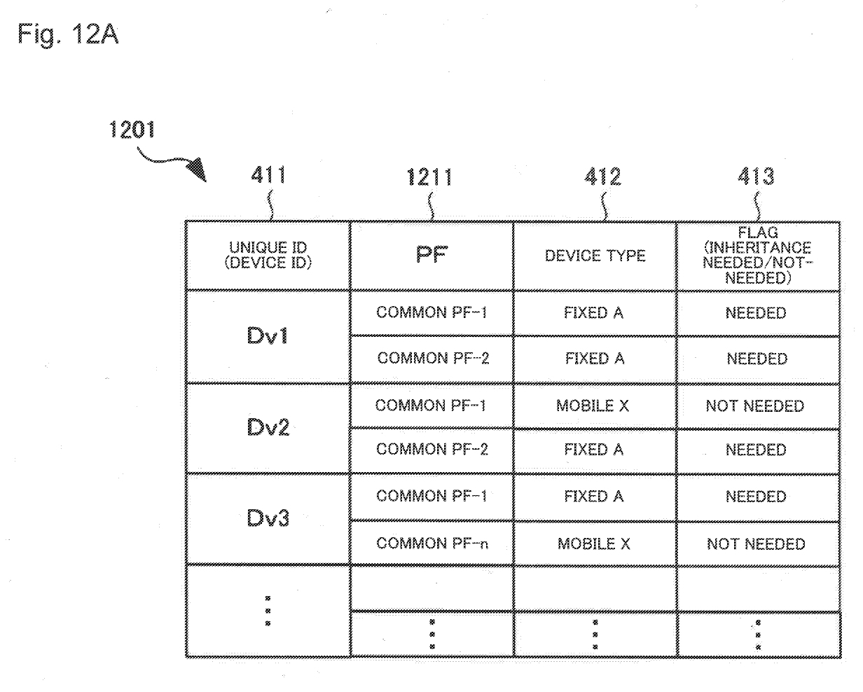

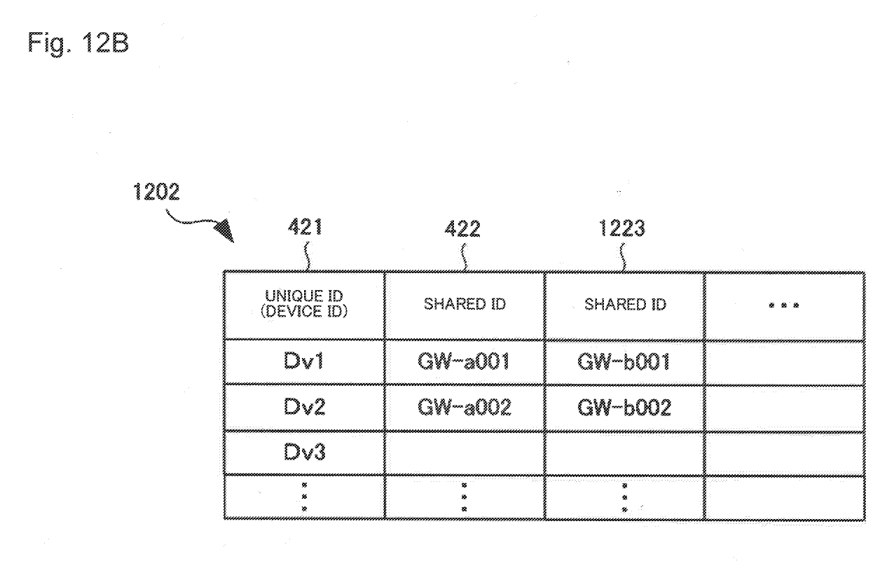

FIG. 12A is a diagram illustrating a configuration of a determination table 1201 provided in the information processing apparatus 702 included in the information processing system 1100 according to the present example embodiment. FIG. 12B is a diagram illustrating a configuration of a shared ID table 1202 provided in the information processing apparatus 702 included in the information processing system 1100 according to the present example embodiment.

The determination table 1201 stores a PF 1211, a device type 412 and a flag 413 in association with a unique ID 411 (device ID). Since a device 203 in the present example embodiment belongs to the two common PFs 201 and 1101, the PF 1211 indicates the common PFs 201 and 1101 to which the device 203 belongs.

The shared ID table 1202 stores shared IDs 422 and 1223 in association with a unique ID 421. Since a device 203 in the present example embodiment belongs to a plurality of common PFs 201 and 1101, shared IDs 422 and 1223 are stored in association with the respective common PFs 201 and 1101.

The information processing apparatus 702 determines whether or not to add shared IDs to device data by referring to the determination table 1201. Similarly, the information processing apparatus 702 acquires an association between a unique ID and shared IDs by referring to the shared ID table 1202 and adds the shared IDs to device data.

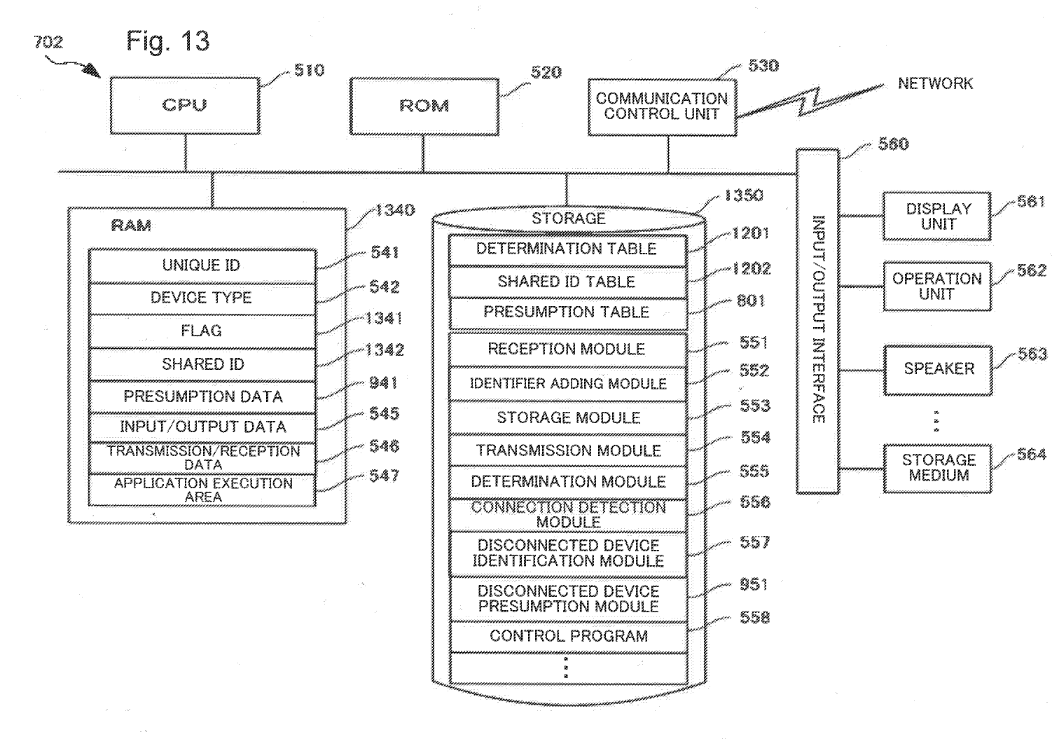

FIG. 13 is a block diagram illustrating a hardware configuration of the information processing apparatus 702 included in the information processing system 1100 according to the present example embodiment. A RAM 1340 is a random access memory used by the CPU 510 as a temporary-storage work area. An area for storing data required for implementing the present example embodiment is reserved in the RAM 1340. A flag 1341 is an indicator indicating whether or not device data needs to be inherited. These items of data are data loaded from the determination table 1201 illustrated in FIG. 12A. Shared ID 1342 is data used for adding shared IDs to device data. The data are data loaded from the shared ID table 1202 illustrated in FIG. 12B.

A database and various kinds of parameters or the following data or programs required for implementing the present example embodiment are stored in a storage 1350. The storage 1350 stores the determination table 1201 and the shared ID table 1202. The determination table 1201 is the table illustrated in FIG. 12A that is used for determining whether or not shared IDs need to be added. The shared ID table 1202 is the table illustrated in FIG. 12B that stores a correspondence relationship between a unique ID and shared IDs.

According to the present example embodiment, continuity of device data before and after replacement (change) of a device can be maintained even when a device belongs to a plurality of common PFs, because a plurality of shared IDs are added to the device data.

### Other Example Embodiments

While the present invention has been described with reference to example embodiments, the present invention is not limited to the example embodiments described above. Various changes that can be understood by those skilled in the art can be made to configurations and details of the present invention within the scope of the present invention. Further, a system or an apparatus implemented by combining separate features included in the respective example embodiments in any manner is also included in the scope of the present invention.

Note that an information processing apparatus may be a mobile router, for example, and in that case, may be a M2M gateway (gateway apparatus) defined in oneM2M. An M2M gateway is equivalent to a middle node (MN) in the oneM2M architecture and includes a common services entry (CSE). Note that a CSE in an MN is also called MN-CSE.

A network may be a mobile communication network provided by a communication carrier, for example, and may be an underlying network defined in oneM2M.

Further, a device may be a sensor device, for example, and may be an M2M device defined in oneM2M. An M2M device is equivalent to an application service node (ASN) or an application dedicated node (ADN) in the oneM2M architecture and the ASN has a CSE. Note that a CSE in an ASN is also called ASN-CSE.

Further, the present invention may be applied to a system that is made up of a plurality of pieces of equipment or may be applied to a single apparatus. Moreover, the present invention is also applicable to a case where an information processing program that implements functions of an example embodiment is directly or remotely provided to a system or an apparatus. Accordingly, a program that is installed into a computer in order to implement functions of the present invention by a computer, or a medium storing the program, or a World Wide Web (WWW) server that allows the program to be downloaded is also included in the scope of the present invention. In particular, a non-transitory computer readable medium storing a program that causes a computer to execute at least processing steps included in any of the example embodiments described above is included in the scope of the present invention.

This application is based upon and claims the benefit of priority from Japanese Patent Application No. 2016-058492, filed on Mar. 23, 2016, the entire disclosure of which is incorporated herein.

What is claimed is:

1. An information processing apparatus comprising:
reception unit which receives device data transmitted from a device;
identifier adding unit which acquires a correspondence relationship between a device identifier that uniquely identifies the device and a shared identifier, and adding the shared identifier to the device data; and
transmission unit which transmits device data to which the shared identifier is added.

2. The information processing apparatus according to claim 1, further comprising determination unit which determines whether or not to add the shared identifier to the device data received from the device, wherein
the identifier adding unit adds the shared identifier to the device data, based on a determination result.

3. The information processing apparatus according to claim 1 or 2, claim 1, further comprising:
connection detection unit which detects connection of a new device; and
disconnected device identification unit which identifies a disconnected device when connection of the new device is detected.

4. The information processing apparatus according to claim 3, further comprising disconnected device presumption unit which presumes a disconnected device, wherein
the disconnected device identification unit identifies a disconnected device, based on a presumption result.

5. The information processing apparatus according to claim 4, wherein
the disconnected device presumption unit presumes a disconnected device, based on at least any one of an interval at which the device data are received, position information of the device, and a distance to the device.

6. An information processing method comprising:
a reception step of receiving device data transmitted from a device;
an identifier adding step of acquiring a correspondence relationship between a device identifier that uniquely identifies the device and a shared identifier, and adding the shared identifier to the device data; and
a transmission step of transmitting device data to which the shared identifier is added.

7. A computer-readable non-transitory recording medium on which information processing program is recorded, the program causing a computer to execute:
a reception step of receiving device data transmitted from a device;
an identifier adding step of acquiring a correspondence relationship between a device identifier that uniquely identifies the device and a shared identifier, and adding the shared identifier to the device data; and
a transmission step of transmitting device data to which the shared identifier is added.

8. (canceled)
